(19) United States
(12) Patent Application Publication
(10) Pub. No.: US 2025/0262890 A1
(43) Pub. Date: Aug. 21, 2025

(54) WHEEL THEFT PREVENTION SYSTEM

(71) Applicant: Ford Global Technologies, LLC, Dearborn, MI (US)

(72) Inventors: Ricardo Hernandez, Tlalnepantla de Baz (MX); Michel Bechara, Mexico City (MX); Antonio Sanchez, Mexico City (MX); Luis Alfredo Servin, Mexico City (MX); Emmanual Enrique Alonso Sanchez, Metepec (MX)

(21) Appl. No.: 18/581,061

(22) Filed: Feb. 19, 2024

(51) Int. Cl. B60B 7/16; E05B 47/00; E05B 81/06; E05B 81/42

(52) U.S. Cl. CPC B60B 7/16; E05B 81/06; E05B 81/42; E05B 2047/0094

(57) ABSTRACT

An anti-theft system for a wheel assembly may include a wheel body having a rim portion on which a tire is mountable and a rotational axis, a wheel hub operably coupled to a shaft or axle of the vehicle and to which the wheel body is mountable, and a lock assembly having a locked state in which the lock assembly engages both the wheel hub and the wheel body to prevent removal of the wheel body from the wheel hub, and having an unlocked state in which at least one of the wheel hub or the wheel body is not engaged by the lock assembly to enable removal of the wheel bod from the wheel hub. The lock assembly may be disposed between the wheel hub and the wheel body and blocked from view by the wheel body.

### TECHNICAL FIELD

Example embodiments generally relate to vehicle wheel assemblies and, more particularly, relate to a wheel theft prevention system to prevent the theft of vehicle wheels.

### BACKGROUND

On average, 950 complete sets of wheels are stolen daily in the US. This is generally because lug nuts can be removed and typical anti-theft devices can be forcibly removed from the outside of the wheel.

Accordingly, it may be desirable to provide an anti-theft design that cannot be accessed from outside the wheel. Moreover, if the design can further not even be visible from outside the wheel, additional security may be provided.

### BRIEF SUMMARY OF SOME EXAMPLES

In accordance with an example embodiment, an anti-theft system for a wheel assembly may be provided. The system may include a wheel body having a rim portion on which a tire is mountable and a rotational axis, a wheel hub operably coupled to a shaft or axle of the vehicle and to which the wheel body is mountable, and a lock assembly having a locked state in which the lock assembly engages both the wheel hub and the wheel body to prevent removal of the wheel body from the wheel hub, and having an unlocked state in which at least one of the wheel hub or the wheel body is not engaged by the lock assembly to enable removal of the wheel bod from the wheel hub. The lock assembly may be disposed between the wheel hub and the wheel body and blocked from view by the wheel body.

In another example embodiment, a lock assembly for providing an anti-theft function for a wheel assembly of a vehicle that includes a wheel body having a rim portion on which a tire is mountable and a rotational axis and a wheel hub operably coupled to a shaft or axle of the vehicle and to which the wheel body is mountable may be provided. The lock assembly includes a locking mechanism operable to transition the lock assembly between a locked state in which the lock assembly engages both the wheel hub and the wheel body to prevent removal of the wheel body from the wheel hub and an unlocked state in which at least one of the wheel hub or the wheel body is not engaged by the lock assembly to enable removal of the wheel bod from the wheel hub without removal of the wheel body. The lock assembly also includes a hub contact plate that interfaces with the wheel hub, and a carrying plate that interfaces with the locking mechanism to rotate and carry a portion of the lock assembly between the locked and unlocked states responsive to operation of the locking mechanism.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a block diagram of an anti-theft system for vehicle wheels in accordance with an example embodiment;

FIG. 2 illustrates a perspective view of a wheel body to which a lock assembly of the anti-theft system may be applied in accordance with an example embodiment;

FIG. 3 illustrates an exploded view of components of an anti-theft system of vehicle wheels in accordance with an example embodiment;

FIG. 4A illustrates a front view of portions of a lock assembly and locking mechanism of an example embodiment;

FIG. 4B is a side view of the lock assembly and locking mechanism of FIG. 4A in accordance with an example embodiment;

FIG. 4C illustrates a back view of the lock assembly and locking mechanism of FIG. 4A in accordance with an example embodiment;

FIG. 5 illustrates an exploded perspective view of the lock assembly and locking mechanism components in accordance with an example embodiment;

FIG. 6A shows an isolated back view of the lock assembly in a locked state in accordance with an example embodiment;

FIG. 6B illustrates an isolated back view of the lock assembly in an unlocked state in accordance with an example embodiment;

FIG. 7A illustrates a cross sectional view of a wheel body having a highlight region A circled therein in accordance with an example embodiment;

FIG. 7B illustrates a cross sectional view of the highlight region A of FIG. 6A in accordance with an example embodiment;

FIG. 8 shows a side view of a hub assembly with a retention blade slot formed in a cup portion thereof in accordance with an example embodiment;

FIG. 9A is a cross section view of components of the anti-theft system in which the lock assembly is in an unlocked state in accordance with an example embodiment;

FIG. 9B is a cross section view of components of the anti-theft system in which the lock assembly is in a locked state in accordance with an example embodiment;

FIG. 10 is an exploded perspective view of the interface between the wheel hub and the lock assembly in accordance with an example embodiment;

FIG. 11 is a detailed view of the interface between an electric motor and the carrying plate in accordance with an example embodiment;

FIG. 12A is a side view of the carrying plate and cam body in isolation in accordance with an example embodiment;; and

FIG. 12B is a side view of a highlighted portion of FIG. 12A in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Some example embodiments described herein may enhance the performance of a vehicle wheel anti-theft system by introducing a locking mechanism that is not visible and cannot be accessed without taking of a center cap that is also lockable itself. Such a locking mechanism may provide an effective solution to wheel thefts that allows vehicle owners to be comfortable in the security of their wheels. Not only may the solution give peace of mind to vehicle owners, but proliferation of the solution may discourage potential thieves due to its complex design and hidden location.

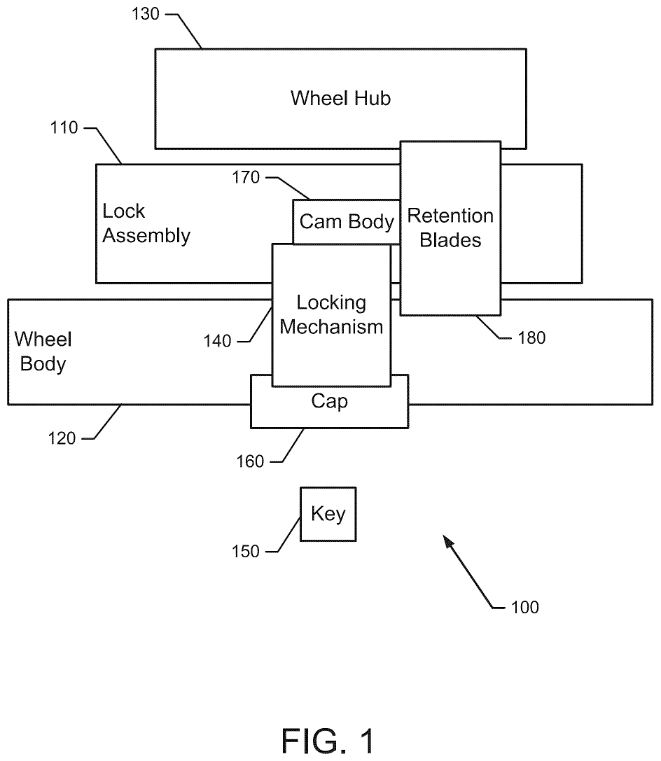

FIG. 1 illustrates a block diagram of a wheel assembly 100 employing a lock assembly 110 of an example embodiment. The wheel assembly 100 may include a wheel body 120 and a wheel hub 130. The wheel body 120 may include a rim to which tires of the vehicle are operably coupled, and may include retention holes through which lugs pass that operably couple the wheel body 120 to the wheel hub via attachment of lug nuts to the lugs. These lug nuts, even if designed to be so-called anti-theft lug nuts, are typically visible and accessible from outside the wheel body 120 and are therefore typically able to be forced off by thieves. This vulnerability is what the lock assembly 110 aims to address.

To accomplish this, the lock assembly 110 may be entirely hidden from view behind the wheel body 120, and may lock the wheel hub 130 to the wheel body 120. However, the lock assembly 110 may be operable via a locking mechanism 140 either electronically or via an external key 150 that accesses/operates the locking mechanism 140 from outside the wheel body 120. When operated electronically, an onboard motor may be remotely actuated to operate the locking mechanism 140. If power is lost, if the onboard motor is otherwise inoperable, or if desired, the key 150 may be used to interact physically with the locking mechanism 140 either through a cap 160 at a center of the wheel body 120 or behind the cap 160. The cap 160 may otherwise be similar to a normal wheel cap that has branding or other decorative features thereon.

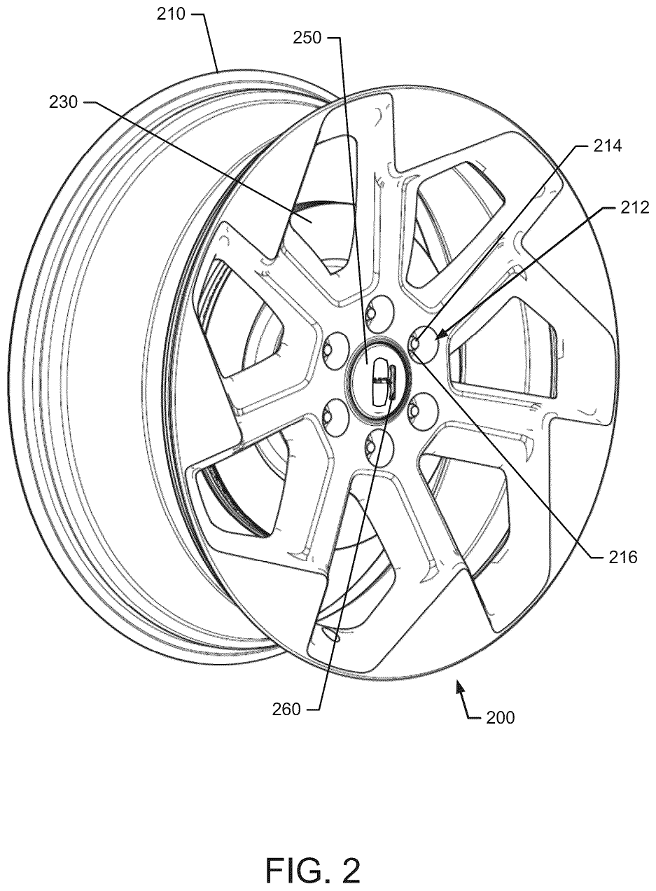

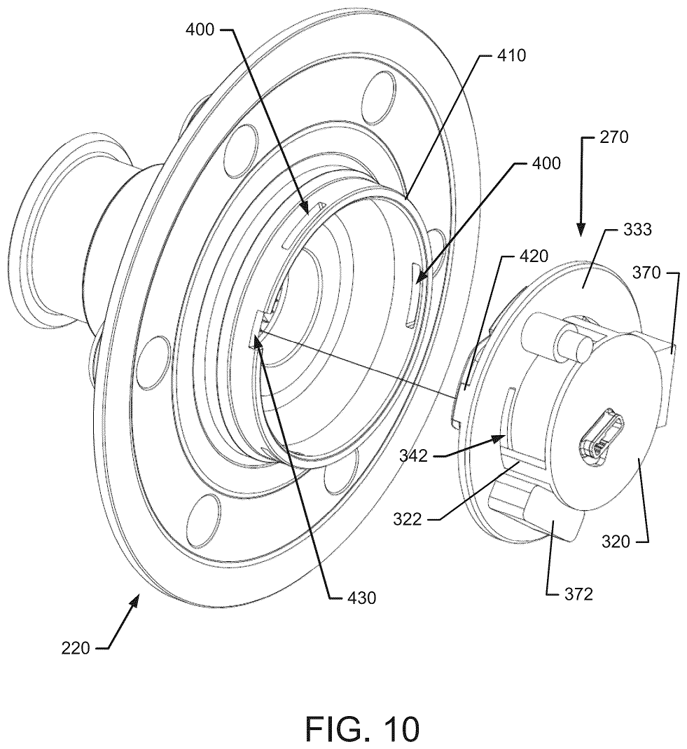

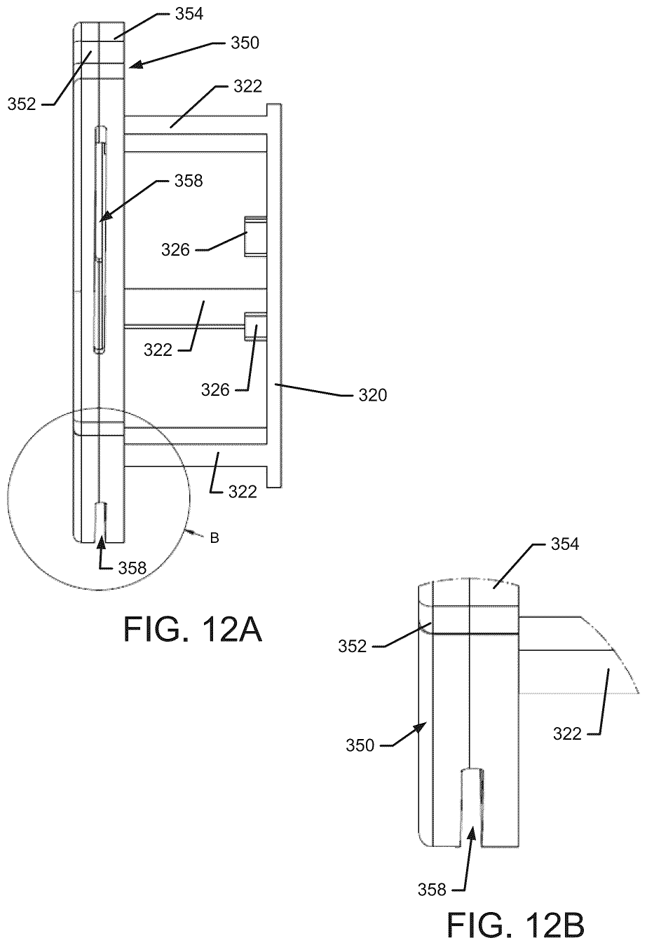

When the locking mechanism 140 is operated to lock or unlock the lock assembly 110, some embodiments may employ a cam body 170 that actuates retention blades 180. When the locking mechanism 140 is locked (or shifted to a locked state), the cam body 170 may rotate to urge the retention blades 180 to extend and engage both the wheel body 120 and the wheel hub 130. When the locking mechanism 140 is unlocked (or shifted to an unlocked state), the cam body 170 may rotate to draw the retention blades 180 inward such that at least one, and sometimes both, of the wheel body 120 and the wheel hub 130 are no longer engaged by the retention blades 180. FIGS. 2-12B illustrate some physical examples of structures that may be employed to implement the components discussed generally above in reference to FIG. 1.

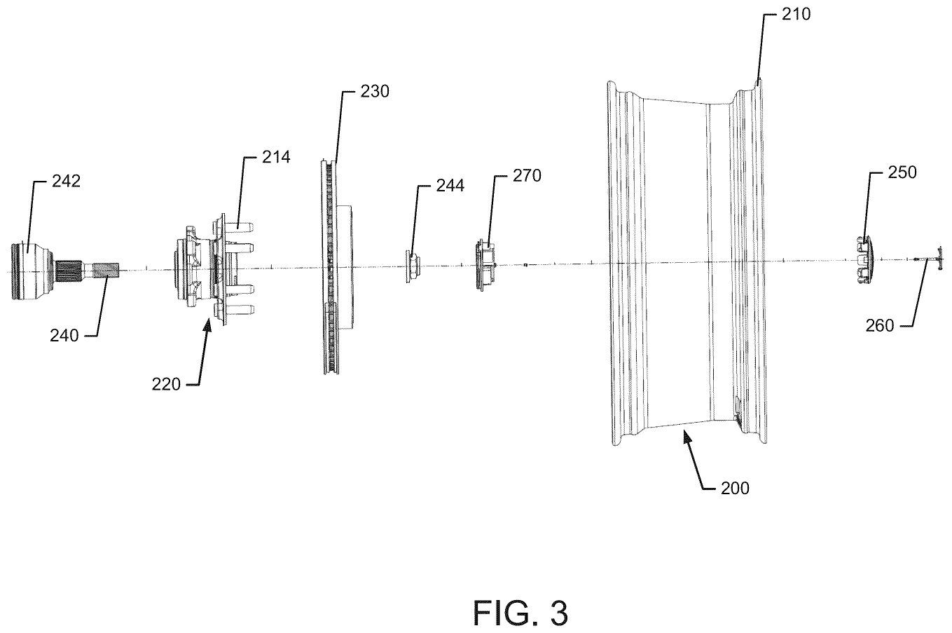

FIG. 2 illustrates a perspective view of a wheel body 200 (an example of wheel body 120 in FIG. 1), and FIG. 3 illustrates an exploded view of the wheel body 200 and various other components of, or that interface with, an anti-theft system employing an example implementation of the lock assembly 110 of FIG. 1. The wheel body 200 includes a rim portion 210 to which a tire may be attached, and a plurality of retention holes 212 through which lugs 214 pass that operably couple the wheel body 200 to a wheel hub and bearing assembly 220 (e.g., an example of the wheel hub 130 of FIG. 1) via attachment of lug nuts 216 to the lugs 214. The lugs 214 may also pass through a portion of a brake disc 230 and both the wheel hub and bearing assembly 220 and the brake disc 230 may be secured to the vehicle via a threaded shaft portion 240 of a shaft (or half shaft) of an axle 242. In this regard, a retention nut 244 may attach to the threaded shaft portion 240 to secure the axle 242 to the wheel hub and bearing assembly 220 and the brake disc 230.

FIGS. 2 and 3 also show an example of a cap 250 that may insert into a center portion of the wheel body 200, and a key 260 that can pass through a keyway or key hole located in the cap 250. The cap 250 is an example of the cap 160 and the key 260 is an example of the key 150 of FIG. 1. Meanwhile, the lock assembly 110 of FIG. 1 is exemplified by lock assembly 270 in FIG. 3. Notably, as can be seen from FIG. 3 (and appreciated from FIG. 2), when fully assembled, the lock assembly 270 is located behind the wheel body 200 (relative to an external viewer looking at the vehicle from a side view of the vehicle). Thus, visibility of the lock assembly 270 is entirely obscured, and a potential thief would not even know that the protective measure exists. Moreover, the lock assembly 270 is also not physically accessible without the key 260. As such, whereas the lock assembly 270 may be in either a locked state, or an unlocked state, the potential thief can neither observe the current state, nor determine how to transition between states by virtue of the inability to see and interact with the lock assembly 270.

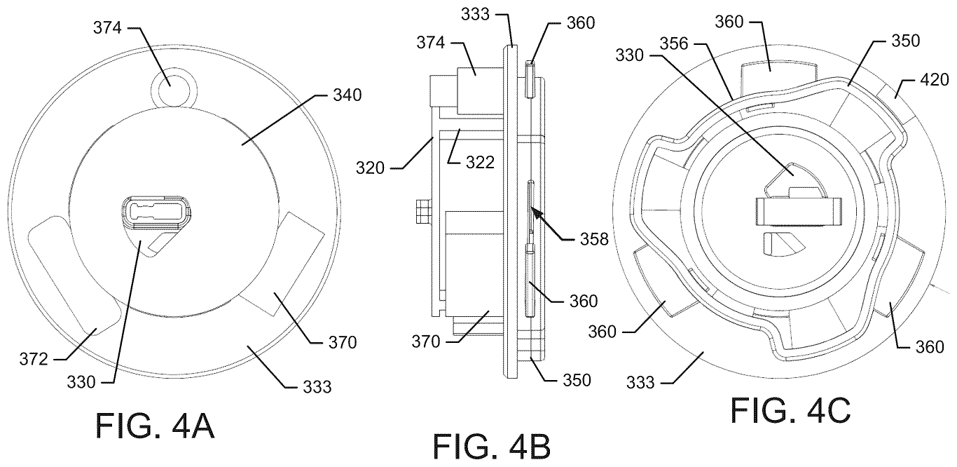

As noted above, in a typical situation, the retention nut 244 may secure the wheel hub and bearing assembly 220 and the brake disc 230, and the wheel body 200 may be secured to the wheel hub and bearing assembly 220 (with the lock assembly 270 between the wheel hub and bearing assembly 220 and the wheel body 200) via the lug nuts 216. Whereas the lug nuts 216 can be removed, if the lock assembly 270 is in the locked state, the wheel body 200 may remain secured to the wheel hub and bearing assembly 220 via the lock assembly 270. In this regard, the lock assembly 270 may include a locking mechanism 300 shown at least in part in FIGS. 4A, 4B, 4C, 5, 6A and 6B, which facilitate transferring the lock assembly 270 between the locked and unlocked states.

In the locked state, the lock assembly 270 may engage both the wheel hub and bearing assembly 220 and the wheel body 200 to prevent removal of the wheel body 200 from the wheel hub and bearing assembly 220. In the unlocked state, the lock assembly 270 may release one or both of the wheel hub and bearing assembly 220 and the wheel body 200. Thus, for example, at least one of the wheel hub and bearing assembly 220 and the wheel body 200 is not engaged by the lock assembly in the unlocked state to enable removal of the wheel body 200 from the wheel hub and bearing assembly 220. Moreover, the transition between this enablement or disablement for wheel body 200 removal is itself accomplished without removal of the wheel body 200 (to provide visibility and physical access to the lock assembly 270.

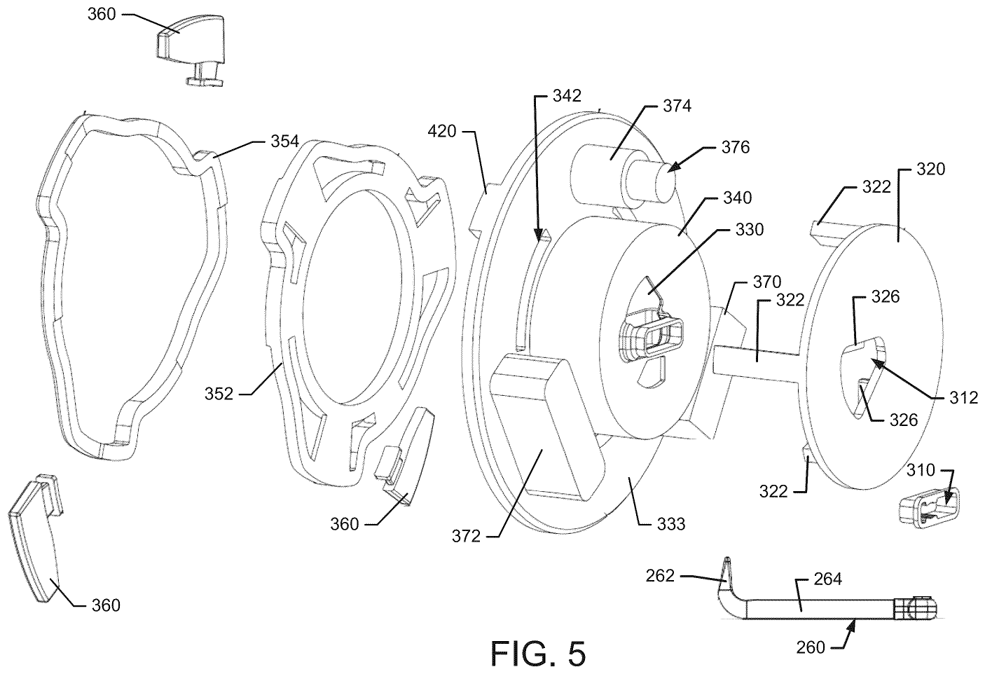

The lock assembly 270 may be physically structured in various different ways to perform the functions described above. One such example structure is shown in FIGS. 4A-6B. Referring now to FIGS. 4A to 6B, the lock assembly 270 may include the locking mechanism 300 that transfers the lock assembly 270 between the locked and unlocked states. The locking mechanism 300 may be operable via the key 260 passing through keyway 310 formed in the cap 250. The key 260 (a side view of which is shown in FIG. 5) may also have an actuating portion 262 that extends substantially perpendicularly away from a shaft portion 264. The keyway 310 may be shaped to have an opening complementary to the shape of the actuating portion 262 of the key 260. Thus, a device other than the key 260, or shaped differently than the key 260, may not pass through the keyway 310.

The actuating portion 262, when inserted through the keyway 310, may then pass through a key slot 312 formed in a carrying plate 320 of the lock assembly 270. After passing through the key slot 312, the key 260 may engage a rotary lock body 330 disposed in a main body 340 of the lock assembly 270. The main body 340 may house the rotary lock body 330, which may rotate responsive to turning the key 260 (based on urging of the actuating portion 262 responsive to twisting or rotating the shaft portion 264). The rotary lock body 330 may in turn be operably coupled to the carrying plate 320 via protrusions 326 on the carrying plate 320 that interface with the rotary lock body 330. Thus, when the rotary lock body 330 rotates, the carrying plate 320 also rotates.

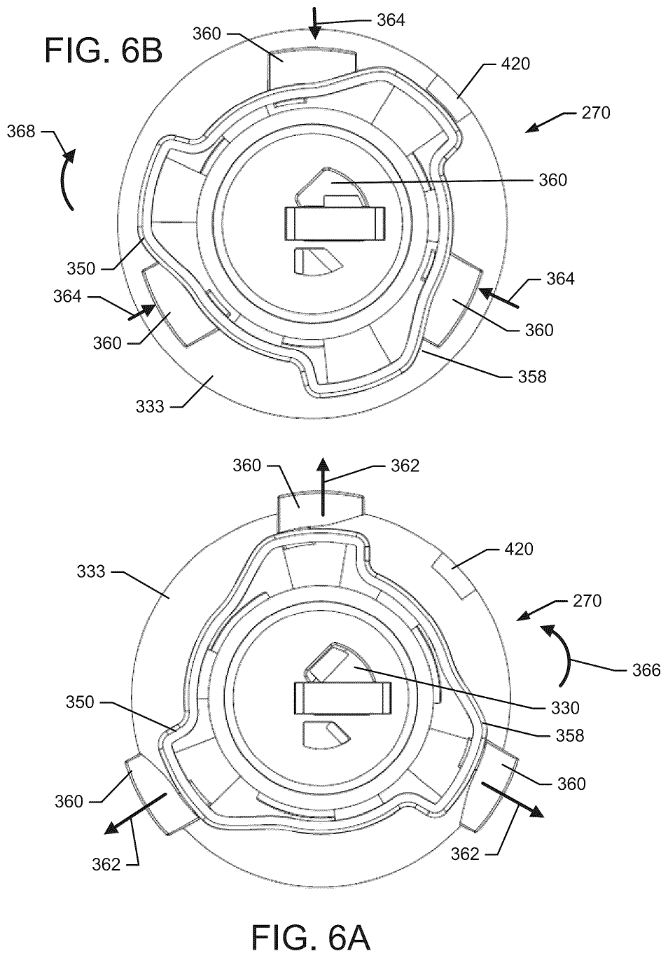

The carrying plate 320 may include legs 322 that extend through respective rotary slots 342 formed in the main body 340 radially outward of the rotary lock body 330. The legs 322 may engage a cam body 350 disposed on an opposite side of the main body 340 relative to the carrying plate 320. The cam body 350 may include a first cam body portion 352 and a second cam body portion 354 that are joined together to form the cam body 350. The first and second cam body portions 352 and 354 may be generally complementary to each other in relation to shapes of their respective peripheral edges. However, each of the first and second cam body portions 352 and 354 may have gaps therebetween at respective camming surfaces 356. The gaps may form blade sliding slots 358 inside which retention blades 360 may be slidably retained. The retention blades 360 may be fixed in their angular positions relative to a rotational axis of the cam body 350 and the rotary lock body 330, but may be enabled to slide within the blade sliding slots 358 along the respective camming surfaces 356 to either extend the retention blades 360 radially outward (as shown by arrow 362 in FIG. 6A) or withdraw the retention blades 360 radially inward (as shown by arrow 364 in FIG. 6B) depending on which way the rotary lock body 330 and the carrying plate 320 rotate. In an example embodiment, the rotary lock body 330 may be rotated in a first direction shown by arrow 366 to transition from the unlocked state of FIG. 6B to the locked state of FIG. 6A. Conversely, the rotary lock body 330 may rotate in a second direction shown by arrow 368 to transition from the locked state of FIG. 6A to the unlocked state of FIG. 6B.

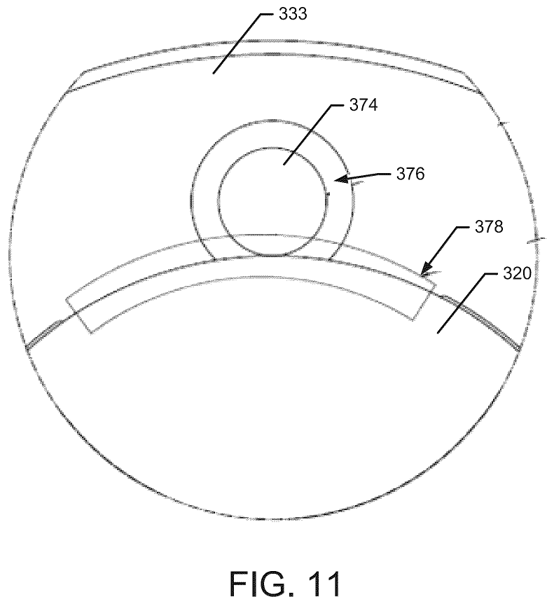

Notably, although the rotary lock body 330 may rotate responsive to turning of the key 260 as described above, an automated or wirelessly actuated operation of the locking mechanism 300 may also or alternatively be provided. In this regard, for example, the main body 340 of some example embodiments may further house a battery 370 (or other local power source), a wireless communication module 372, and an electric motor 374 (e.g., a servo motor). The wireless communication module 372 and the electric motor 374 may each be powered by the battery 370. Moreover, the wireless communication module 372 may be configured to receive a wireless trigger signal communicated external to the lock assembly 270 and/or locking mechanism 300, and actuate the electric motor 374. The electric motor 374 may turn and, via a gear assembly interface with the carrying plate 320, cause the carrying plate 320 to also turn. In some cases (as shown in FIG. 11), an external periphery of a portion of the electric motor 374 may include a lead gear 376 that interfaces with a corresponding spur gear 378 formed at a peripheral edge of the carrying plate 320. Turning of the electric motor 374 may then turn the lead gear 376, which turns the spur gear 378 and rotates the carrying plate 320.

In an example embodiment, each individual one of the retention blades 360 may be aligned with a respective corresponding one of a set of first retention blade slots 400 formed in a portion of the wheel hub and bearing assembly 220. In this regard, for example, the lock assembly 270 may be shaped to fit or nest within a cup portion 410 of the wheel hub and bearing assembly 220. In an example embodiment, three separate instances of the retention blades 360 may be provided as part of the lock assembly 270, and the retention blades 360 may be separated from each other angularly by 120 degrees. The first retention slots 400 may be separated from each other also by 120 degrees to permit alignment with the retention blades 360. Moreover, a portion of the main body 340 (e.g., a hub contact plate 333) may include a locating protrusion 420 that may be aligned with a locating slot 430 formed at a distal end of the cup portion 410 of the wheel hub and bearing assembly 220. When the locating protrusion 420 is received in the locating slot 430, the retention blades 360 may be aligned with (and in some cases inserted into) the first retention blade slots 400.

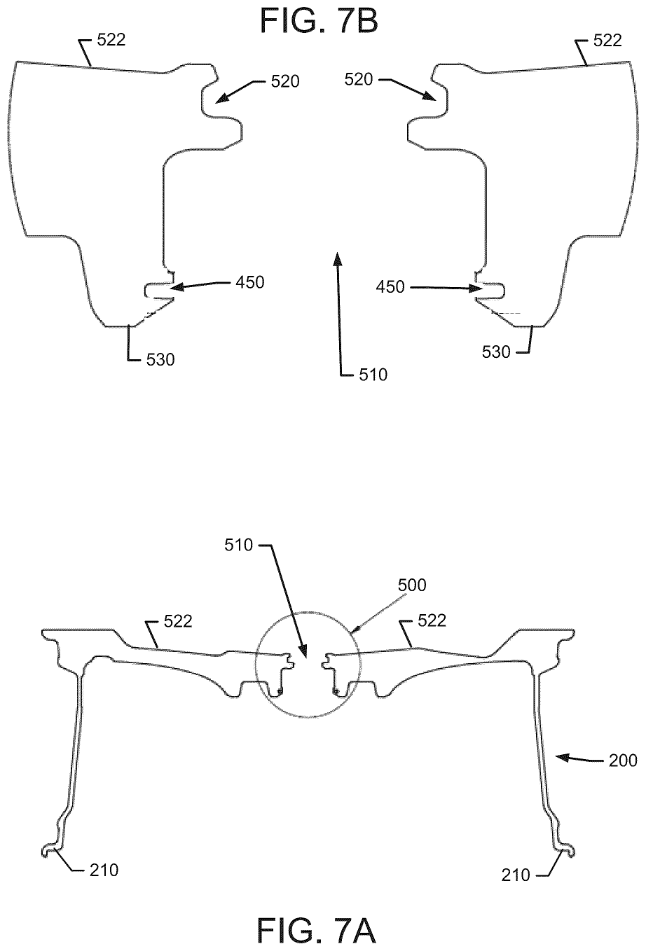

Rotation of the cam body 350 (responsive to rotation of the carrying plate 320 either via the key 260 or wireless triggering and operation of the electric motor 374) in one direction may drive the retention blades 360 outward via the camming surface 356 pushing the retention blades 360 outward through the first retention blade slots 400 and into a corresponding set of second retention blade slots 450 formed at a portion of the wheel body 200 as shown in FIGS. 7A and 7B to transition the lock assembly 270 to the locked state. Rotation in the opposite direction, withdraws the retention blades 360 to transition the lock assembly 270 to the unlocked state. FIG. 7B shows the wheel body 200 in cross section along a plane passing through the axis of rotation of the wheel body 200. A center portion 500 of the wheel body 200 is highlighted by a circle in FIG. 7A, and shown in greater detail in FIG. 7B.

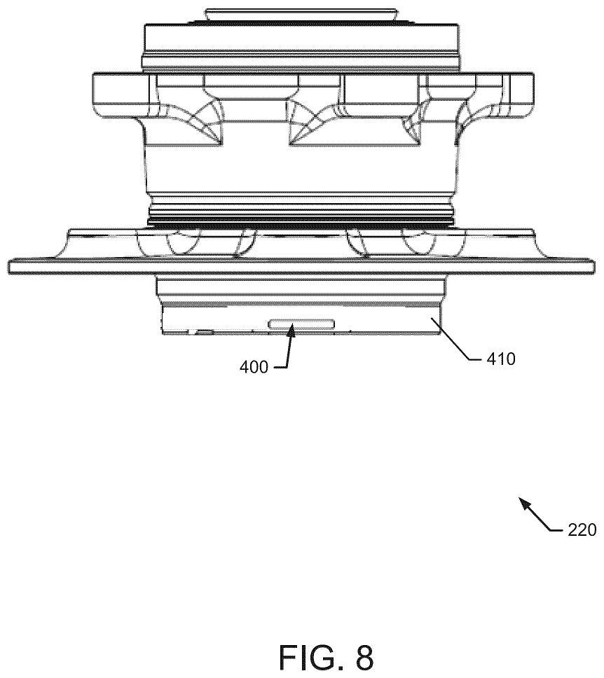

An axial passage 510 may extend axially through the wheel body 200, and may include a cap retention slot 520 at an exterior side 522 of the wheel body 200 annularly extending around the axial passage 510. The cap 250 may be received and retained in the cap retention slot 520. The axial passage 510 may be further bounded by additional reinforcing material (e.g., metal) to form a solid core or hub for the wheel body 200. As this additional reinforcing material extends inwardly away from the exterior side 522 of the wheel body 200 it may reach a distal end 530. Proximate to the distal end 530, the second retention blade slots 450 may be formed in the wheel body 200 in alignment with the first retention blade slots 400. However, it should be noted that the second retention blade slots 450 may, in some cases, be formed as a single continuous slot that extends entirely around the wheel body 200 instead of being discretely located proximate to the first retention blade slots 400. FIG. 8 shows a side view of the wheel hub and bearing assembly 220 with lugs 214 removed, to particularly show the location of one instance of the first retention blade slots 400 in the cup portion 410.

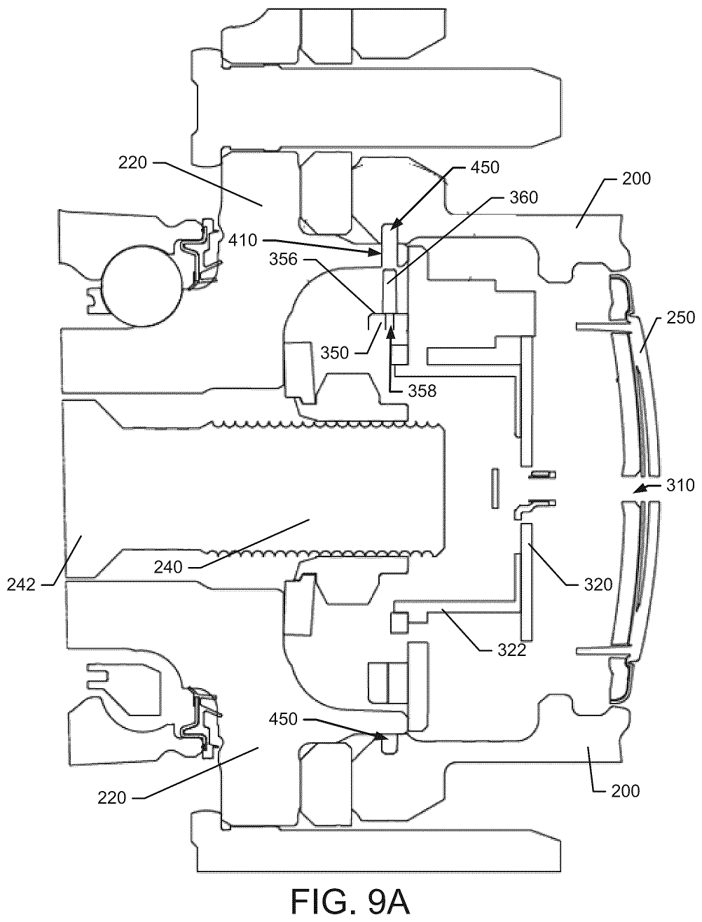

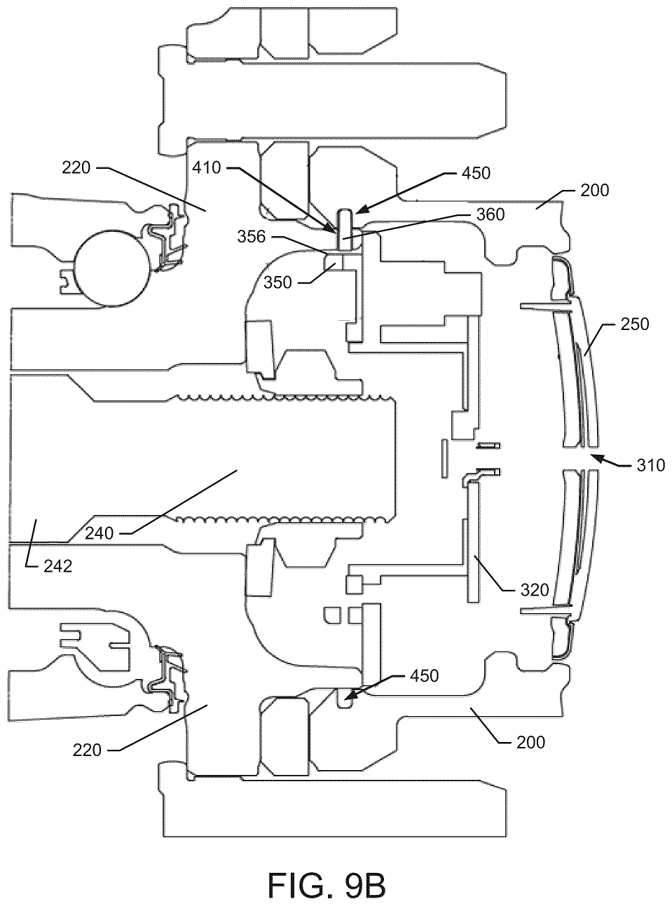

Turning now to FIGS. 9A and 9B, cross section views of the entire system in an assembled condition are shown in both the unlocked state (FIG. 9A) and the locked state (FIG. 9B). In this regard, in FIG. 9A, the cam body 350 can be seen with one instance of the retention blades 360 riding in its corresponding instance of the blade sliding slots 358 along the camming surface 356. In the unlocked state, the retention blade 360 is actually neither inside the first retention blade slot 400 formed in the cup portion 410 of the wheel hub and bearing assembly 220, nor inside the second retention blade slot 450 formed proximate the distal end 530 of the wheel body 200. However, when the locking mechanism 300 is operated to transition the lock assembly 270 to the locked state, then the cam body 350 is rotated to the position of FIG. 9B, and the retention blade 360 rides in the blade sliding slot 358 along the camming surface 356 to extend the retention blade 360 into both the first retention blade slot 400 formed in the cup portion 410 of the wheel hub and bearing assembly 220, and the second retention blade slot 450 formed proximate the distal end 530 of the wheel body 200 as shown in FIG. 9B.

A lock assembly for providing an anti-theft function for a wheel assembly of a vehicle that includes a wheel body having a rim portion on which a tire is mountable and a rotational axis and a wheel hub operably coupled to a shaft or axle of the vehicle and to which the wheel body is mountable may therefore be provided. The lock assembly includes a locking mechanism operable to transition the lock assembly between a locked state in which the lock assembly engages both the wheel hub and the wheel body to prevent removal of the wheel body from the wheel hub and an unlocked state in which at least one of the wheel hub or the wheel body is not engaged by the lock assembly to enable removal of the wheel bod from the wheel hub without removal of the wheel body. The lock assembly also includes a hub contact plate that interfaces with the wheel hub, and a carrying plate that interfaces with the locking mechanism to rotate and carry a portion of the lock assembly between the locked and unlocked states responsive to operation of the locking mechanism.

The lock assembly (or an anti-theft system including the same) of some embodiments may include additional features, modifications, augmentations and/or the like to achieve further objectives or enhance performance of the device. The additional features, modifications, augmentations and/or the like may be added in any combination with each other. Below is a list of various additional features, modifications, and augmentations that can each be added individually or in any combination with each other. For example, the lock assembly may be disposed between the wheel hub and the wheel body and blocked from view by the wheel body. In an example embodiment, the locking mechanism may be operable via a remote trigger signal actuating the locking mechanism. Alternatively or additionally, the locking mechanism may be operable via a key passing through a keyway formed in a cap disposed at the rotational axis of the wheel body. In some cases, the lock assembly may further include a cam body operably coupled to the carrying plate to move responsive to movement of the carrying plate and one or more instances of a retention blade. The retention blade may extend radially outwardly from the rotational axis responsive to the carrying plate rotating cam body in a first direction to transition to the locked state. The retention blade may also withdraw radially inwardly with respect to the rotational axis responsive to rotation of the cam body in a second direction to transition to the unlocked state. In an example embodiment, the wheel hub may include a first retention blade slot, and the wheel body may include a second retention blade slot aligned with the first retention blade slot to receive the retention blade in both the first and second retention blade slots when the lock assembly is in the locked state. In some cases, the lock assembly may include a locating protrusion and the wheel hub comprises a locating slot disposed at a distal end of a cup portion of the wheel hub, and the lock assembly may be nested inside the cup portion with the locating protrusion received in the locating slot to align the retention blade with both the first and second retention blade slots. In an example embodiment, the cam body may include a blade sliding slot formed in a peripheral portion of a camming surface, and the retention blade may slide through the blade sliding slot along the camming surface to transition into and out of engagement with the wheel hub and the wheel body responsive to rotation of the cam body in the first and second directions, respectively. In some cases, the one or more instances of the retention blade may include a set of three retention blades, and the set of three retention blades may be separated from each other by about 120 degrees around a periphery of the cam body. In an example embodiment, the locking mechanism may be operable via a remote trigger signal to rotate the cam body via an electric motor, and, responsive to a loss of power to the electric motor, or inoperability of the electric motor, an operator of the vehicle may be notified to operate the locking mechanism via a key passing through a keyway formed in a cap disposed at the rotational axis of the wheel body.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. An anti-theft system for a wheel assembly, the system comprising:
a wheel body having a rim portion on which a tire is mountable and a rotational axis;
a wheel hub operably coupled to a shaft or axle of the vehicle and to which the wheel body is mountable; and
a lock assembly having a locked state in which the lock assembly engages both the wheel hub and the wheel body to prevent removal of the wheel body from the wheel hub, and having an unlocked state in which at least one of the wheel hub or the wheel body is not engaged by the lock assembly to enable removal of the wheel body from the wheel hub,
wherein the lock assembly is disposed between the wheel hub and the wheel body and blocked from view by the wheel body.

2. The system of claim 1, wherein the lock assembly comprises a locking mechanism operable to transition the lock assembly between the locked state and the unlocked state without removal of the wheel body.

3. The system of claim 2, wherein the locking mechanism is operable via a remote trigger signal actuating the locking mechanism.

4. The system of claim 2, wherein the locking mechanism is operable via a key passing through a keyway formed in a cap disposed at the rotational axis of the wheel body.

5. The system of claim 2, wherein the lock assembly comprises a cam body and one or more instances of a retention blade,
wherein the retention blade extends radially outwardly from the rotational axis responsive to rotation of the cam body in a first direction to transition to the locked state, and
wherein the retention blade withdraws radially inwardly with respect to the rotational axis responsive to rotation of the cam body in a second direction to transition to the unlocked state.

6. The system of claim 5, wherein the wheel hub comprises a first retention blade slot, and the wheel body comprises a second retention blade slot aligned with the first retention blade slot to receive the retention blade in both the first and second retention blade slots when the lock assembly is in the locked state.

7. The system of claim 6, wherein the lock assembly comprises a locating protrusion and the wheel hub comprises a locating slot disposed at a distal end of a cup portion of the wheel hub, and
wherein the lock assembly is nested inside the cup portion with the locating protrusion received in the locating slot to align the retention blade with both the first and second retention blade slots.

8. The system of claim 5, wherein the cam body includes a blade sliding slot formed in a peripheral portion of a camming surface, and
wherein the retention blade slides through the blade sliding slot along the camming surface to transition into and out of engagement with the wheel hub and the wheel body responsive to rotation of the cam body in the first and second directions, respectively.

9. The system of claim 5, wherein the one or more instances of the retention blade include a set of three retention blades, and
wherein the set of three retention blades are separated from each other by about 120 degrees around a periphery of the cam body.

10. The system of claim 5, wherein the locking mechanism is operable via a remote trigger signal to rotate the cam body via an electric motor, and
responsive to a loss of power to the electric motor, or inoperability of the electric motor, an operator of the vehicle is notified to operate the locking mechanism via a key passing through a keyway formed in a cap disposed at the rotational axis of the wheel body.

11. A lock assembly for providing an anti-theft function for a wheel assembly of a vehicle comprising a wheel body having a rim portion on which a tire is mountable and a rotational axis and a wheel hub operably coupled to a shaft or axle of the vehicle and to which the wheel body is mountable, the lock assembly comprising:
a locking mechanism operable to transition the lock assembly between a locked state in which the lock assembly engages both the wheel hub and the wheel body to prevent removal of the wheel body from the wheel hub and an unlocked state in which at least one of the wheel hub or the wheel body is not engaged by the lock assembly to enable removal of the wheel body from the wheel hub;
a hub contact plate that interfaces with the wheel hub; and
a carrying plate that interfaces with the locking mechanism to rotate and carry a portion of the lock assembly between the locked and unlocked states responsive to operation of the locking mechanism.

12. The lock assembly of claim 11, wherein the lock assembly is disposed between the wheel hub and the wheel body and blocked from view by the wheel body.

13. The lock assembly of claim 11, wherein the locking mechanism is operable via a remote trigger signal actuating the locking mechanism.

14. The lock assembly of claim 11, wherein the locking mechanism is operable via a key passing through a keyway formed in a cap disposed at the rotational axis of the wheel body.

15. The lock assembly of claim 11, further comprising a cam body operably coupled to the carrying plate to move responsive to movement of the carrying plate and one or more instances of a retention blade,
wherein the retention blade extends radially outwardly from the rotational axis responsive to the carrying plate rotating cam body in a first direction to transition to the locked state, and
wherein the retention blade withdraws radially inwardly with respect to the rotational axis responsive to rotation of the cam body in a second direction to transition to the unlocked state.

16. The lock assembly of claim 15, wherein the wheel hub comprises a first retention blade slot, and the wheel body comprises a second retention blade slot aligned with the first retention blade slot to receive the retention blade in both the first and second retention blade slots when the lock assembly is in the locked state.

17. The lock assembly of claim 16, wherein the lock assembly comprises a locating protrusion formed on the hub contact plate and the wheel hub comprises a locating slot disposed at a distal end of a cup portion of the wheel hub, and
wherein the lock assembly is nested inside the cup portion with the locating protrusion received in the locating slot to align the retention blade with both the first and second retention blade slots.

18. The lock assembly of claim 15, wherein the cam body includes a blade sliding slot formed in a peripheral portion of a camming surface, and
wherein the retention blade slides through the blade sliding slot along the camming surface to transition into and out of engagement with the wheel hub and the wheel body responsive to rotation of the cam body in the first and second directions, respectively.

19. The lock assembly of claim 15, wherein the one or more instances of the retention blade include a set of three retention blades, and
wherein the set of three retention blades are separated from each other by about 120 degrees around a periphery of the cam body. 20 The lock assembly of claim 15, wherein the locking mechanism is operable via a remote trigger signal to rotate the cam body via an electric motor, and
responsive to a loss of power to the electric motor, or inoperability of the electric motor, an operator of the vehicle is notified to operate the locking mechanism via a key passing through a keyway formed in a cap disposed at the rotational axis of the wheel body.
